(19) United States
(12) Patent Application Publication
(10) Pub. No.: US 2012/0120890 A1
(43) Pub. Date: May 17, 2012

(54) APPARATUS AND METHOD FOR TRANSMITTING MULTIMEDIA DATA IN MULTIMEDIA SERVICE PROVIDING SYSTEM

(75) Inventor: Uk Jang, Seoul (KR)

(73) Assignee: Electronics and Telecommunications Research Institute, Daejeon (KR)

(21) Appl. No.: 13/294,505

(22) Filed: Nov. 11, 2011

(30) Foreign Application Priority Data
Nov. 12, 2010 (KR) 10-2010-0112833
Nov. 10, 2011 (KR) 10-2011-0117172

(51) Int. Cl. H04W 72/04

(52) U.S. Cl. 370/329

(57) ABSTRACT

A multimedia data transmission apparatus in a multimedia service providing system includes: a receiving unit configured to receive information of a terminal communicating with a plurality of access points from the access points; an access point selecting unit configured to select two or more access points to communicate with the terminal which is to receive multimedia data in different frequency bands, based on the terminal information; an allocating unit configured to allocate multimedia data in predetermine frequency bands to the two or more access points, respectively, from the multimedia data in different frequency bands such that the access points transmit the multimedia data in different frequency bands through cooperation therebetween; and a data transmitting unit configured to transmit the multimedia data in different frequency bands to the respective access points through transport layers corresponding to the multimedia data in different frequency bands.

### CROSS-REFERENCES TO RELATED APPLICATIONS

The present application claims priority of Korean Patent Application Nos. 10-2010-0112833 and 10-2011-0117172, filed on Nov. 12, 2010, and Nov. 10, 2011, respectively, which are incorporated herein by reference in their entirety.

### BACKGROUND OF THE INVENTION

1. Field of the Invention

Exemplary embodiments of the present invention relate to a multimedia service providing system; and, more particularly, to an apparatus and method for transmitting multimedia data through cooperation of access points around a terminal.

2. Description of Related Art

When the link capacity is limited due to the restrictions of the distance or the channel environment between a source node and a destination node, a multimedia service providing system may form a virtual MIMO (Multiple Input Multiple Output) system by sharing resources such as frequency bands and antennas of adjacent relays. Thus, it may also be applied to an MIMO system through terminals with a single antenna.

Herein, the relay is configured to relay data, received from the source node, by an amplify-and-forward scheme and a decode-and-forward scheme. Accordingly, the destination node (e.g., a terminal) can increase an SNR (Signal to Noise Ratio), but it has to divide an available time slot into two orthogonal time slots for use. In the first time slot, the source node transmits a transmission (TX) signal to the relay and the destination node. In the second time slot, the relay processes the TX signal, received from the source node, according to a relay scheme and relays the resulting signal to the destination node. The use of relays requires more available time slots in the system. Extensive research is being conducted to reduce a waste of time slots and achieve a cooperative diversity effect.

### SUMMARY OF THE INVENTION

An embodiment of the present invention is directed to a multimedia data transmission apparatus and method for transmitting multimedia data through cooperative diversity in a multimedia data providing system.

Another embodiment of the present invention is directed to a multimedia data transmission apparatus and method capable of acquiring cooperative diversity without wasting time slots.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a multimedia data transmission apparatus in a multimedia service providing system includes: a receiving unit configured to receive information of a terminal communicating with a plurality of access points from the access points; an access point selecting unit configured to select two or more access points to communicate with the terminal which is to receive multimedia data in different frequency bands, based on the terminal information; an allocating unit configured to allocate multimedia data in predetermine frequency bands to the two or more access points, respectively, from the multimedia data in different frequency bands such that the access points transmit the multimedia data in different frequency bands through cooperation therebetween; and a data transmitting unit configured to transmit the multimedia data in different frequency bands to the respective access points through transport layers corresponding to the multimedia data in different frequency bands.

The terminal information may include identifier information of the terminal and distance information between the terminal and the access points communicating with the terminal.

The allocating unit may allocate multimedia data in a low frequency band among the multimedia data in different frequency bands to an access point positioned at a short distance from the terminal among the two or more access points, based on the distance information.

The data transmitting unit may transmit the multimedia data in the low frequency band to the access point positioned at the short distance through transport layers in the low frequency band corresponding to the multimedia data in the low frequency band.

The allocating unit may allocate multimedia data in a high frequency band among the multimedia data in different frequency bands to an access point positioned at a long distance from the terminal among the two or more access points, based on the distance information.

The data transmitting unit may transmit the multimedia data in the high frequency band to the access point positioned at the long distance through transport layers in the high frequency band corresponding to the multimedia data in the high frequency band.

The multimedia data transmission apparatus may further include a synchronization information generating unit configured to generate synchronization information to synchronize transmission time points of the multimedia data in different frequency bands, allocated to the two or more access points, respectively.

The data transmitting unit may receive the synchronization information, synchronize the multimedia data in different frequency bands through the synchronization information, and transmit the multimedia data to the two or more access points, respectively.

The allocating unit may allocate transport layers in the predetermined frequency bands, corresponding to the multimedia data in the predetermined frequency bands, to the respective access points.

In accordance with another embodiment of the present invention, a multimedia data transmission method in a multimedia service providing system includes: receiving information of a terminal communicating with a plurality of access points from the access points; allocating multimedia data in predetermined frequency bands among multimedia data in different frequency bands to two or more access points communicating with the terminal, respectively, among the plurality of access points such that the two or more access points transmit the multimedia data in different frequency bands through cooperation therebetween; and transmitting the multimedia data in different frequency bands to the respective access points through transport layers corresponding to the multimedia data in different frequency bands.

The terminal information may include identifier information of the terminal and distance information between the terminal and the access points communicating with the terminal.

Said allocating the multimedia data in predetermined frequency bands among the multimedia data in different frequency bands to the two or more access points communicating with the terminal, respectively, among the plurality of access points may include allocating multimedia data in a low frequency band among the multimedia data in different frequency bands to an access point positioned at a short distance from the terminal among the two or more access points, based on the distance information.

Said transmitting the multimedia data in different frequency bands to the respective access points through the transport layers corresponding to the multimedia data in different frequency bands may include transmitting the multimedia data in the low frequency band to the access point positioned at the short distance through transport layers in the low frequency band corresponding to the multimedia data in the low frequency band.

Said allocating the multimedia data in predetermined frequency bands among the multimedia data in different frequency bands to the two or more access points communicating with the terminal, respectively, among the plurality of access points may include allocating multimedia data in a high frequency band among the multimedia data in different frequency bands to an access point positioned at a long distance from the terminal among the two or more access points, based on the distance information.

Said transmitting the multimedia data in different frequency bands to the respective access points through the transport layers corresponding to the multimedia data in different frequency bands may include transmitting the multimedia data in the high frequency band to the access point positioned at the long distance through transport layers in the high frequency band corresponding to the multimedia data in the high frequency band.

Said allocating the multimedia data in predetermined frequency bands among the multimedia data in different frequency bands to the two or more access points communicating with the terminal, respectively, among the plurality of access points may include allocating transport layers in the predetermined frequency bands, corresponding to the multimedia data in the predetermined frequency bands, to the respective access points.

The multimedia data transmission method may further include generating and transmitting synchronization information to synchronize transmission time points of the multimedia data in different frequency bands, allocated to the two or more access points, respectively.

### BRIEF DESCRIPTION OF THE DRAWINGS

FIG. 1 is a block diagram of a multimedia service providing system in accordance with an embodiment of the present invention.

FIG. 2 is a block diagram of a scheduler illustrated in FIG. 1.

FIG. 3 is a diagram illustrating multimedia data in different frequency bands, which are transmitted to access points by the scheduler illustrated in FIG. 1.

FIG. 4 is a block diagram of an access point illustrated in FIG. 1.

FIG. 5 is a diagram illustrating a structure of a wireless network for transmission of multimedia data in accordance with an embodiment of the present invention.

FIG. 6 is a diagram illustrating a structure of a wireless network for transmission of multimedia data in accordance with another embodiment of the present invention.

FIG. 7 is a flow chart illustrating an operation of the scheduler illustrated in FIG. 2.

FIG. 8 is a flow chart illustrating an operation of the access point illustrated in FIG. 4.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention provides a scheduler for cooperative communication of multimedia data in a multimedia service system, and a multimedia data transmitting method thereof.

For example, the multimedia service system of the present invention includes a mobile IPTV (Internet Protocol Television) system providing a multimedia service (e.g., an IPTV service) to mobile terminals.

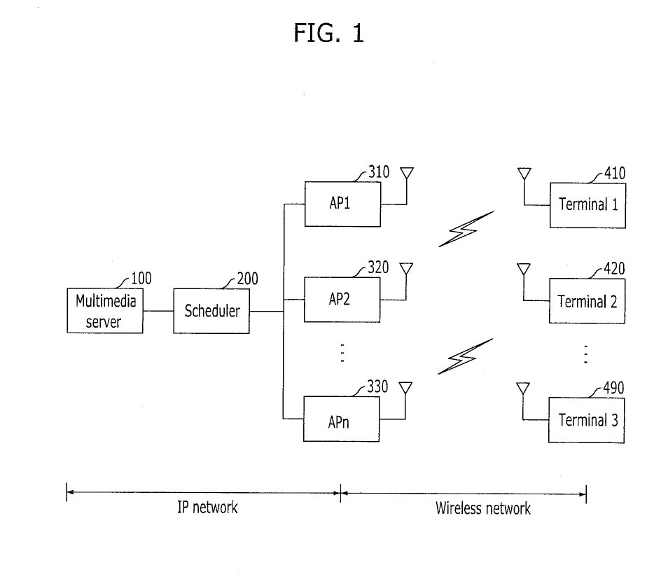

FIG. 1 is a block diagram of a multimedia service providing system in accordance with an embodiment of the present invention.

Referring to FIG. 1, a multimedia service providing system in accordance with an embodiment of the present invention includes a multimedia server 100, a scheduler 200, a plurality of access points 310, 320, and 330, and a plurality of terminals 410, 420 and 430.

The multimedia server 100 generates or stores multimedia data. The multimedia server 100 may receive multimedia data generated by an external device. For example, the multimedia data may include IPTV videos. The multimedia server 100 outputs multimedia data in different frequency bands to the scheduler 200. Herein, the multimedia data outputted from the multimedia server 100 to the scheduler 200 may be divided into multimedia data of different frequencies (e.g., low-frequency multimedia data and high-frequency multimedia data).

In order to divide the multimedia data into multimedia data of different frequencies, the multimedia server 100 may include band-pass filters (BPFs) configured to filter different frequency bands. For example, the multimedia data of a low frequency band include essential video data sensitive to users, and the multimedia data of a high frequency band include additional video data for video improvement.

The scheduler 200 receives the multimedia data in different frequency bands. In order to transmit the multimedia data in different frequency bands to a terminal through cooperation of the plurality of access points 310, 320, and 330, the scheduler 200 outputs the multimedia data in different frequency bands to the access points 310, 320, and 330 through a scheduling operation. Herein, the scheduler 200 outputs only multimedia data in a predetermined frequency band corresponding to each of the respective access points 310, 320, and 330, among the multimedia data in different frequency bands, to the corresponding access point, and the scheduling operation of the scheduler 200 will be described below in detail.

The access points 310, 320, and 330 may provide termination information to the scheduler 200 in order for the scheduling operation to transmit the multimedia data in different frequency bands. Herein, the terminal information may include identifier information of terminals communicable with the access points 310, 320, and 330, and distance information between the communicable terminals and the access points 310, 320, and 330. The access points 310, 320, and 330 may transmit the multimedia data in different frequency bands, received from the scheduler 200, to terminals communicating with the access points 310, 320, and 330.

The terminals 410, 420, and 430 receive the multimedia data in predetermined frequency bands from the access points 310, 320, and 330 communicable with the terminals, and combine the received multimedia data in predetermined frequency bands. The terminals 410, 420, and 430 output the combined multimedia data to users.

The multimedia server 100, the scheduler 200, and the access points 310, 320, and 330 may form an IP network; and the access points 310, 320, and 330 and the terminals 410, 420 and 430 may form a wireless network.

The scheduler 200 performs a scheduling operation as follows.

The scheduler 200 receives multimedia data having different frequencies from the multimedia server 100, and performs a scheduling operation to transmit the multimedia data having different frequencies to the access points 310, 320, and 330.

The scheduler 200 receives the terminal information from the access points 310, 320, and 330, and schedules the multimedia data in different frequency bands on the basis of the terminal information. The scheduler 200 performs a scheduling operation to transmit the multimedia data in different frequency bands through cooperation between different access points, using the identifier information of the terminals communicable with the respective access points 310, 320, and 330 among the terminal information. Also, the scheduler 200 schedules the multimedia data in different frequency bands to the access points 310, 320, and 330, based on the distance information between the access points and the communicable terminal in the terminal information. For example, the scheduler 200 schedules the multimedia data in different frequency bands such that an access point positioned at a relatively short distance from the terminal among the access points 310, 320, and 330 transmits multimedia data in a low frequency band, among the multimedia data in different frequency bands, to the terminal. That is, the scheduler 200 allocates the multimedia data in the low frequency band to the access point positioned at the relatively short distance. Furthermore, the scheduler 200 schedules the multimedia data in different frequency bands such that an access point positioned at a relatively long distance from the terminal among the access points 310, 320, and 330 transmits multimedia data in a high frequency band, among the multimedia data in different frequency bands, to the terminal. That is, the scheduler 200 allocates the multimedia data in the high frequency band to the access point positioned at the relatively long distance.

That is, the scheduler 200 allocates the multimedia data in predetermined frequency bands to the respective access points from the multimedia data in different frequency bands, based on the distance information between the terminal and the access points 310, 320, and 330.

In this embodiment of the present invention, the scheduler 200 performs a scheduling operation to transmit the multimedia data in different frequency bands to the terminal through cooperation of two or more access points. That is, the scheduler 200 performs a scheduling operation to transmit multimedia data to the terminals through cooperative diversity. In particular, the scheduler 200 may use cooperative diversity in consideration of the source characteristics of multimedia data.

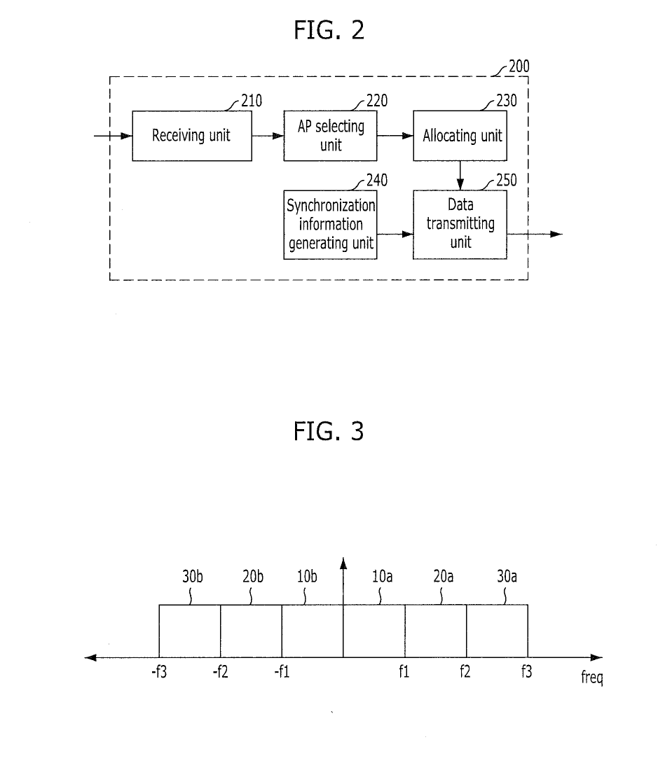

FIG. 2 is a block diagram of the scheduler 200 illustrated in FIG. 1.

Referring to FIG. 2, the scheduler 200 includes a receiving unit 210, an access point selecting unit 220, an allocating unit 230, a synchronization information generating unit 240, and a data transmitting unit 250.

The receiving unit 210 is connected to a plurality of access points through a high-speed backbone, and receives terminal information through a plurality of access points. Furthermore, the receiving unit 210 receives the multimedia data in different frequency bands from the multimedia server 100, and outputs the received terminal information and the multimedia data in different frequency bands to the access point selecting unit 220. The terminal information includes identifier information of the terminals and distance information between the terminals and the access points.

The access point selecting unit 220 selects access points communicable with a terminal to receive the multimedia data in different frequency bands, based on the terminal information (e.g., terminal identifier information). That is, the access point selecting unit 220 selects access points to transmit the multimedia data in different frequency bands to the terminal, and outputs information of the selected access points to the allocating unit 230.

The allocating unit 230 allocates transport layers having different frequency bands corresponding to the multimedia data in different frequency bands to the respective access points selected for the multimedia data in different frequency bands such that the access points transmit the multimedia data in different frequency bands through cooperation.

For example, the allocating unit 230 allocates transport layers in a low frequency band to an access point positioned at a relatively short distance from the terminal, among two or more access points, such that the access point transmits multimedia data in the low frequency band to the terminal, based on the terminal information (e.g., terminal distance information). Furthermore, the allocating unit 230 allocates transport layers in a high frequency band to an access point positioned at a relatively long distance from the terminal, among two or more access points, such that the access point transmits multimedia data in the high frequency band to the terminal, based on the terminal information (e.g., terminal distance information).

The allocating unit 230 outputs the allocation information on the multimedia data in different frequency bands, allocated to the access points, to the data transmitting unit 250. Herein, the allocation information includes allocation information on multimedia data in a predetermined frequency band, allocated to each of the respective access points from the multimedia data in different frequency bands, or allocation information on transport layers in the predetermined frequency band corresponding to the multimedia data in the predetermined frequency band, allocated to each of the access points.

The synchronization information generating unit 240 generates synchronization information for synchronization between the access points and the multimedia data in the predetermined frequency band, allocated to each of the access points. Furthermore, the synchronization information generating unit 240 outputs the generated synchronization information to the data transmitting unit 250.

The data transmitting unit 250 receives the allocation information, and transmits the multimedia data in the predetermined frequency band, allocated to each of the access points from the multimedia data in different frequency bands. Herein, the data transmitting unit 250 transmits the multimedia data in different frequency bands to the respective access points through transport layers (e.g., a low-frequency transport layer and a high-frequency transport layer) corresponding to the respective multimedia data in different frequency bands.

At this time, the data transmitting unit 250 receives the synchronization information, synchronizes the multimedia data in different frequency bands with the access points corresponding to the respective multimedia data in different frequency bands, and transmits the multimedia data in indifferent frequency bands to the respective access points.

For example, the data transmitting unit 250 transmits multimedia data in a low frequency band through a low-frequency transport layer to an arbitrary access point, e.g., the access point positioned at the short distance. The data transmitting unit 250 transmits multimedia data in a high frequency band through a high-frequency transport layer to an arbitrary access point, e.g., the access point positioned at the long distance.

FIG. 3 is a diagram illustrating the multimedia data in different frequency bands, which the scheduler illustrated in FIG. 1 transmits to the access points.

Referring to FIG. 3, the allocating unit 230 allocates multimedia data 10a and 10b in a low frequency band, among the multimedia data in different frequency bands, to an arbitrary access point among the plurality of access points, e.g., an access point positioned at a relatively short distance, such that the access point transmits the multimedia data 10a and 10b in the low frequency band. The multimedia data 10a and 10b in the low frequency band is located around a center frequency of ‘0’ in the entire frequency band of the multimedia data in different frequency bands. Herein, the multimedia data 10a and 10b in the low frequency band may include multimedia data in a frequency band from ‘0’ to ‘f1’ and multimedia data in a frequency band from ‘0’ to ‘−f1’. Furthermore, the multimedia data 10a and 10b in the low frequency band are acquired by the terminal through a low pass filter.

The allocating unit 230 allocates multimedia data 20a and 20b in a first high frequency band, among the multimedia data in different frequency bands, to an arbitrary access point among the plurality of access points, e.g., an access point positioned at a longer distance than the access point positioned at the short distance, i.e., at a first long distance such that the access point positioned at the first long distance transmits the multimedia data 20a and 20b in the first high frequency band. The multimedia data 20a and 20b in the first high frequency band are located in an outer region of the multimedia data 10a and 10b in the low frequency band from the center frequency of ‘0’ in the entire frequency bands of the multimedia data in different frequency bands. That is, the multimedia data 20a and 20b in the first high frequency band may include multimedia data in a frequency band from ‘f1’ to ‘f2’ and multimedia data in a frequency band from ‘−f1’ to ‘−f2’.

The allocating unit 230 allocates multimedia data 30a and 30b in a second high frequency band, among the multimedia data in different frequency bands, to an arbitrary access point among the plurality of access points, e.g., an access point positioned at a longer distance than the access point positioned at the first long distance, i.e., at a second long distance such that the access point positioned at the second long distance transmits the multimedia data 30a and 30b in the second high frequency band. The multimedia data 30a and 30b in the second high frequency band are located in an outer region of the multimedia data 20a and 20b in the first frequency band from the center frequency of ‘0’ in the entire frequency bands of the multimedia data in different frequency bands. That is, the multimedia data 30a and 30b in the second high frequency band may include multimedia data in a frequency band from ‘f2’ to ‘f3’ and multimedia data in a frequency band from ‘−f2’ to ‘−f3’. Furthermore, the multimedia data 20a, 20b, 30a, and 30b in the first and second high frequency bands are acquired by the terminal through a band pass filter.

Herein, it is assumed that there are first to third access points communicable with the terminal. It is assumed that the first access point is nearest to the terminal and the third access point is remotest from the terminal. It is assumed that the second access point is remoter from the terminal than the first access point and is nearer to the terminal than the third access point.

That is, the allocating unit 230 may allocate the multimedia data in different frequency bands to the respective access points in consideration of the distance information received from the access points (i.e., the first to third access points). The allocating unit 230 may allocate the low-frequency band to the first access point. The allocating unit 230 allocates the multimedia data 10a and 10b in the low frequency band to the first access point, allocates the multimedia data 20a and 20b in the first frequency band to the second access point, and allocates the multimedia data 30a and 30b in the second frequency band to the third access point.

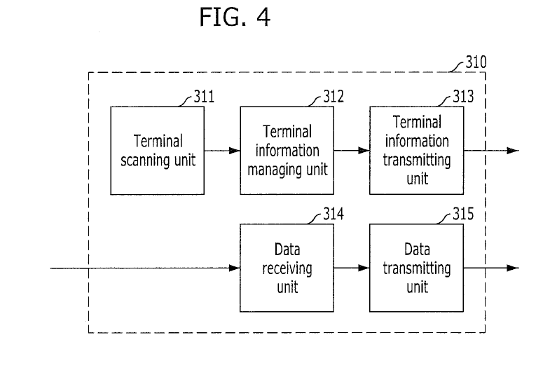

FIG. 4 is a block diagram of the access point 310 illustrated in FIG. 1.

Referring to FIG. 4, the access point 310 includes a terminal scanning unit 311, a terminal information managing unit 312, a terminal information transmitting unit 313, a data receiving unit 314, and a data transmitting unit 315.

The terminal scanning unit 311 scans terminals around the access point 310. The terminal scanning unit 311 may acquire information about a communicable terminal through a scanning operation. That is, the terminal scanning unit 311 may acquire information about an identifier of a communicable terminal and information about the distance from the communicable terminal. The terminal scanning unit 311 outputs the scanned terminal information to the terminal information managing unit 312.

The terminal information managing unit 312 receives the terminal information and manages the terminal information. The terminal information managing unit 312 may update information about the scanned terminal at predetermined periods. The terminal information managing unit 312 outputs the terminal information to the terminal information transmitting unit 313.

The terminal information transmitting unit 313 may transmit the terminal information to the scheduler 200 for multimedia data scheduling.

The data receiving unit 314 receives multimedia data in a predetermined frequency band from scheduler 200. The data receiving unit 314 outputs the received multimedia data to the data transmitting unit 315. Herein, the data receiving unit 314 receives the multimedia data in the predetermined frequency band corresponding to the access point 310, allocated from the multimedia data in different frequency bands by the scheduler 200.

The data transmitting unit 315 transmits the multimedia data in the predetermined frequency band corresponding to the access point 310 to the corresponding terminal. Herein, the data transmitting unit 315 transmits the multimedia data in the predetermined frequency band to the terminal through transport layers corresponding to the multimedia data in the predetermined frequency band allocated through the scheduler 200, i.e., transport layers in the predetermined frequency band

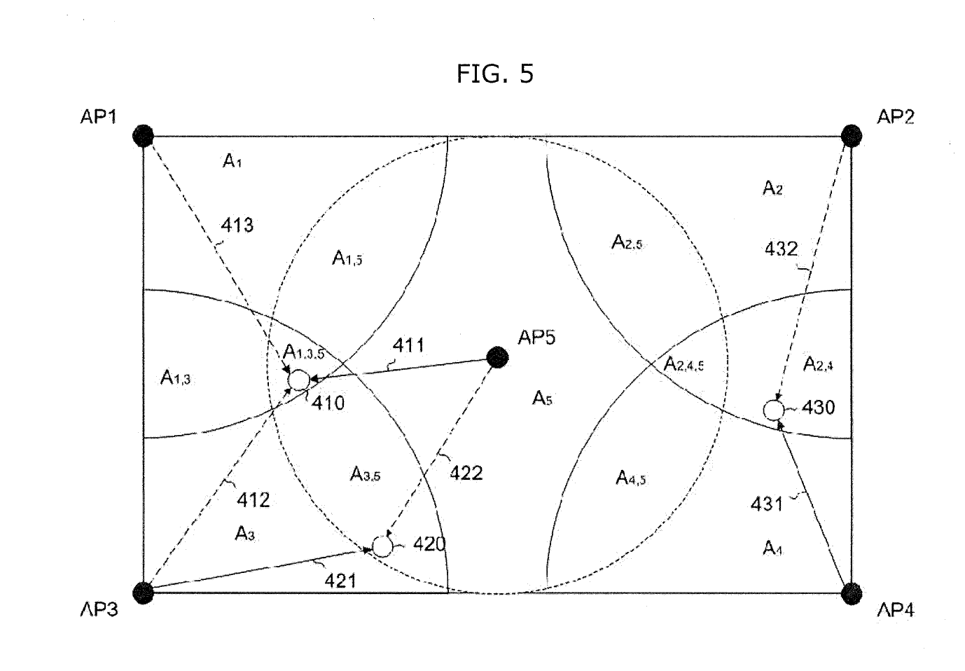

FIG. 5 is a diagram illustrating a structure of a wireless network for transmission of multimedia data in accordance with an embodiment of the present invention.

Referring to FIG. 5, a wireless network in accordance with an embodiment of the present invention includes access points AP1, AP2, AP3, AP4 and AP5 and terminals 410, 420 and 430.

Each of the access points AP1, AP2, AP3, AP4 and AP5 forms a region (i.e., a cell) communicable with a terminal. For example, a cell of each of the first to fourth access points AP1 to AP4 is illustrated as being sector-shaped, and a cell of the fifth access point AP5 is illustrated as being circular.

There is an overlap region between the cells of the access points AP1, AP2, AP3, AP4 and AP5. In the overlap region between the cells, the terminal may receive multimedia data from two or more access points. For example, in a region A_{1,3,5}, an alphabet ‘A’ represents a region divided by the cells of the access points, and numerals ‘1, 3, 5’ represent the identifiers of the access points communicable with a terminal in the corresponding region. Therefore, the terminal located in the region A_{1,3,5} receives multimedia data in different frequency bands from the first access point AP1, the third access point AP3, and the fifth access point AP5.

For example, the first terminal 410 may be located in the region A_{1,3,5}. In this case, the first terminal 410 receives the multimedia data in different frequency bands from the first access point AP1, the third access point AP3, and the fifth access point AP5.

Each of the first, third and fifth access points AP1, AP3 and AP5 may acquire information of the first terminal 410 within the cell and may transmit the acquired information (e.g., the identifier information of the first terminal 410 and the distance information 411, 412 and 413 of the first terminal 410) to the scheduler 200.

The scheduler 200 allocates multimedia data in predetermined frequency bands to the first access point AP1, the third access point AP3, and the fifth access point AP5, respectively, from the multimedia data in different frequency bands such that the first access point AP1, the third access point AP3, and the fifth access point AP5 transmit the multimedia data in different frequency bands to the first terminal 410 through cooperation therebetween.

The scheduler 200 allocates the multimedia data 10a and 10b in the low frequency band to the fifth access point AP5 having the shortest distance 411 from the first terminal 410, allocates the multimedia data 20a and 20b in the first high frequency band to the third access point AP3 having the second shortest distance 412 from the first terminal 410, and allocates the multimedia data 30a and 30b in the second high frequency band to the first access point AP1 having the longest distance 413 from the first terminal 410.

The scheduler 200 transmits the multimedia data in different frequency bands, allocated to the respective access points, i.e., the multimedia data in the low frequency band and the multimedia data in the high frequency bands to the respective access points AP1, AP3 and AP5.

Also, the second terminal 420 may be located in the region A_{3,5}. In this case, the second terminal 420 may receive multimedia data in different frequency bands from the third access point AP3 and the fifth access point AP5.

Each of the third and fifth access points AP3 and AP5 acquires information of the second terminal 420 within the cell and transmits the acquired information (e.g., the identifier information of the second terminal 420 and the distance information 421 and 422 of the second terminal 420) to the scheduler 200.

The scheduler 200 allocates multimedia data in predetermined frequency bands to the third and fifth access points AP3 and AP5, respectively, from the multimedia data in different frequency bands such that the third and fifth access points AP3 and AP5 transmit the multimedia data in different frequency bands to the second terminal 420 through cooperation therebetween.

Herein, the scheduler 200 allocates the multimedia data 10a and 10b in the low frequency band to the third access point AP3 having the shortest distance 421 from the second terminal 420, and allocates the multimedia data 20a and 20b in the first high frequency band to the fifth access point AP5 having the second shortest distance 422 from the second terminal 420.

The scheduler 200 transmits the multimedia data in different frequency bands, i.e., the multimedia data in the low frequency band and the multimedia data in the high frequency band to the respective access points AP3 and AP5.

Also, the third terminal 430 may be located in the region A_{2,4}. In this case, the third terminal 430 receives the multimedia data in different frequency bands from the second access point AP2 and the fourth access point AP4.

Each of the second and fourth access points AP2 and AP4 acquires information of the third terminal 430 within the cell and transmits the acquired information (e.g., the identifier information of the third terminal 430 and the distance information 431 and 432 of the third terminal 430) to the scheduler 200.

The scheduler 200 allocates multimedia data in predetermined frequency bands to the second and fourth access points AP2 and AP4, respectively, from the multimedia data in different frequency bands such that the second and fourth access points AP2 and AP4 transmit the multimedia data in different frequency bands to the third terminal 430 through cooperation therebetween.

The scheduler 200 allocates the multimedia data 10a and 10b in the low frequency band to the fourth access point AP4 having the shortest distance 431 from the third terminal 430, and allocates the multimedia data 20a and 20b in the first high frequency band to the second access point AP2 having the second shortest distance 432 from the third terminal 430.

The scheduler 200 transmits the multimedia data in different frequency bands, i.e., the multimedia data in the low frequency band and the multimedia data in the high frequency band to the respective access points AP2 and AP4.

When receiving the multimedia data in different frequency bands from two or more access points, each of the terminals 410, 420 and 430 decodes and combines the received multimedia data. At this time, the terminals 410, 420, and 430 receive the multimedia data in different frequency bands, allocated to the respective access points through the transport layers corresponding to the multimedia data in different frequency bands, from the corresponding access points.

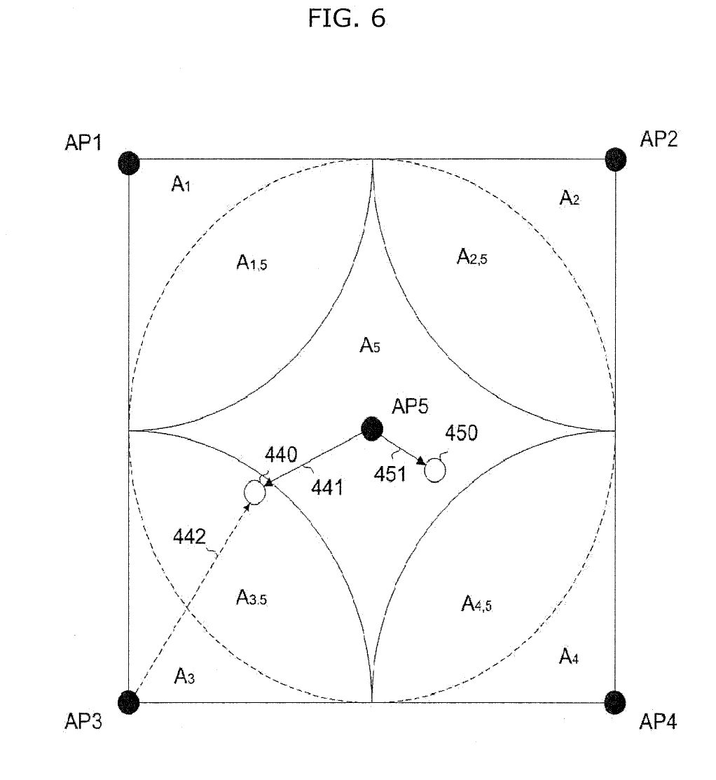

FIG. 6 is a diagram illustrating a structure of a wireless network for transmission of multimedia data in accordance with another embodiment of the present invention.

Referring to FIG. 6, a wireless network in accordance with another embodiment of the present invention includes access points AP1, AP2, AP3, AP4 and AP5 and terminals 440 and 450.

Each of the access points AP1, AP2, AP3, AP4 and AP5 forms a region (i.e., a cell) communicable with a terminal. For example, a cell of each of the first to fourth access points AP1 to AP4 is illustrated as being sector-shaped, and a cell of the fifth access point AP5 is illustrated as being circular.

There is an overlap region between the cells of the access points AP1, AP2, AP3, AP4 and AP5. In the overlap region between the cells, the terminal may receive multimedia data from two or more access points. For example, in a region A_{3,5}, an alphabet ‘A’ represents a region divided by the cells of the access points, and numerals ‘3, 5’ represent the identifiers of the access points communicable with a terminal in the corresponding region. Therefore, the terminal located in the region A_{1,3,5} receives multimedia data in different frequency bands from the third access point AP3 and the fifth access point AP5.

For example, the fourth terminal 440 may be located in the region A_{3,5}. In this case, the fourth terminal 440 receives multimedia data in different frequency bands from the third access point AP3 and the fifth access point AP5.

Each of the third and fifth access points AP3 and AP5 may acquire information of the fourth terminal 440 within the cell and may transmit the acquired information (e.g., the identifier information of the fourth terminal 440 and the distance information 441 and 442 of the fourth terminal 440) to the scheduler 200.

The scheduler 200 allocates multimedia data in predetermined frequency bands to the third and fifth access points AP3 and AP5, respectively, from the multimedia data in different frequency bands such that the third and fifth access points AP3 and AP5 transmit the multimedia data in different frequency bands to the fourth terminal 440 through cooperation therebetween.

Herein, the scheduler 200 allocates the multimedia data 10a and 10b in the low frequency band to the fifth access point AP5 having the shortest distance 441 from the fourth terminal 440, and allocates the multimedia data 20a and 20b in the first high frequency band to the third access point AP3 having the second shortest distance 442 from the fourth terminal 440.

The scheduler 200 transmits the multimedia data in different frequency bands, allocated to the respective access points, i.e., the multimedia data in the low frequency band and the multimedia data in the high frequency band to the respective access points AP3 and AP5.

Also, the fifth terminal 450 may be located in a region A₅. In this case, the fifth terminal 450 receives multimedia data in different frequency bands from the fifth access point AP5.

The fifth access point AP5 acquires information of the fifth terminal 450 within the cell and transmits the acquired information (e.g., the identifier information of the fifth terminal 450 and the distance information 451 of the fifth terminal 450) to the scheduler 200.

The scheduler 200 transmits multimedia data in a predetermined frequency band, among the multimedia data in different frequency bands, to the fifth terminal 450 through the fifth access point AP5.

Herein, the scheduler 200 may allocate multimedia data in a single frequency band to the fifth terminal 450 and the fifth access point AP5, in order to transmit the multimedia data in the predetermined frequency band.

The scheduler 200 transmits the multimedia data in the predetermined frequency band to the access point AP5.

Meanwhile, in FIGS. 5 and 6, a solid-line arrow indicates a transmission path through which the multimedia data in the low frequency band are allocated to the corresponding access points and then transmitted, and a dotted-line arrow represents a transmission path through which the multimedia data in the high frequency band are allocated to the corresponding access points and then transmitted.

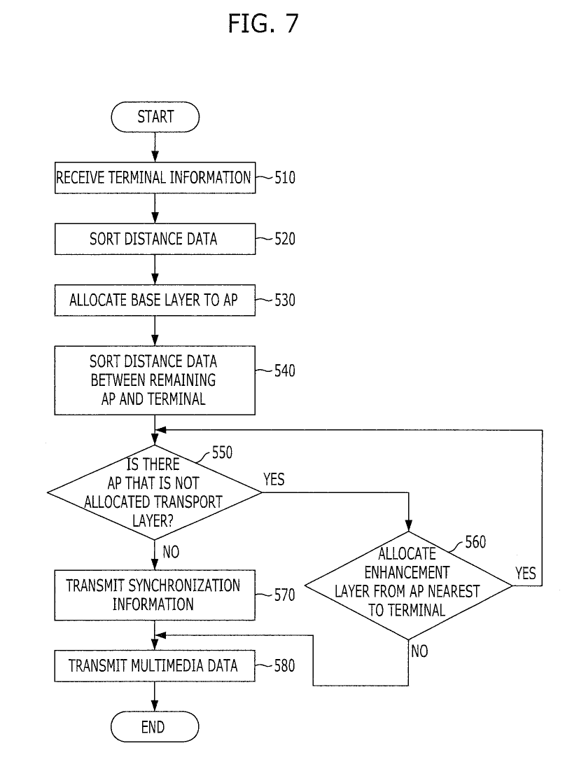

FIG. 7 is a flow chart illustrating an operation of the scheduler 200 illustrated in FIG. 2.

Referring to FIG. 7, at step 510, the receiving unit 210 receives terminal information from a plurality of access points connected through a backbone. For example, the terminal information includes a terminal identifier number k and a distance d from each terminal. The receiving unit 210 receives terminal information, e.g., distance information between the terminal and the access points, and outputs the terminal information to the access point selecting unit 220. The access point selecting unit 220 selects an access point to communicate with a terminal.

At step 520, the allocating unit 230 checks the distance information between the access points and the terminal from the terminal information. At this time, the allocating unit 230 sorts the distance information between the access points and the terminal. The distance information between the access points and the terminal may be sorted according to Equation 1 below.

U={d₁, d₂, d₃, . . . , dₖ},|U|=K Eq. 1

At step 530, the allocating unit 230 allocates multimedia data in a low frequency band, among the multimedia data in different frequency bands, to an access point positioned at the shortest distance from the terminal. At this time, the allocating unit 230 allocates a base layer corresponding to the multimedia data in the low frequency band, i.e., a transport layer in the low frequency band to the access point positioned at the shortest distance from the terminal. Herein, when a k-th access point is the access point positioned at the shortest distance from the terminal, a base layer corresponding to the multimedia data in the low frequency band, allocated to the k-th access point, may be represented by Sₖ. Furthermore, the access point positioned at the shortest distance from the terminal may be selected according to Equation 2 below.

dₖ=max U Eq. 2

At step 540, the allocating unit 230 sorts the distance information between remaining access points and the terminal, after allocating the base layer, that is, allocating the multimedia data in the low frequency band to the access point positioned at the shortest distance from the terminal as described above. The distance information between the remaining access points and the terminal may be sorted according to Equation 3 below.

U=U−{dₖ},|U|=i Eq. 3

At step 550, the allocating unit 230 determines whether or not there is an access point that is not allocated a transport layer, that is, determines whether or not there is an access point that is not allocated multimedia data in a predetermined frequency band among the multimedia data in different frequency bands. Herein, the allocating unit 230 may determine whether or not there is an access point that is not allocated a transport layer, that is, whether or not there is an access point that is not allocated multimedia data in a predetermined frequency band among the multimedia data in different frequency bands, by determining whether ‘i’ in Equation 3 is ‘0’.

When there is an access point that is not allocated a transport layer (at the step 550), the allocating unit 230 proceeds to step 560.

At step 560, the allocating unit 230 allocates multimedia data in a high frequency band, among the multimedia data in different frequency bands, to an access point positioned at the shortest distance from the terminal. At this time, the allocating unit 230 allocates an enhancement layer corresponding to the multimedia data in the high frequency band, i.e., a transport layer in the high frequency band to the access point positioned at the shortest distance from the terminal. Herein, the allocating unit 230 allocates the multimedia data in the high frequency band, adjacent to multimedia data in a low frequency band among the multimedia data in different frequency band, to the access point, that is, allocates the enhancement layer adjacent to the baseband, and the process returns to the step 540. The enhancement layer may be represented as Sₖ=(K−i)^{th}. Furthermore, the allocating unit 230 selects the access point positioned at the shortest distance from the terminal among the remaining access points, according to Equation 2.

When there is no access point that is not allocated a transport layer (at step 550), the allocating unit 230 proceeds to step 570.

At step 570, the data transmitting unit 250 transmits the synchronization information, generated by the synchronization information generating unit 240, to access points for transmission timing synchronization. When receiving the transmission synchronization information, the access points may synchronize transmission timing on the basis of the transmission synchronization information.

At step 580, the data transmitting unit 250 transmits the multimedia data in different frequency bands, allocated to the respective access points, to the corresponding access points. The data transmitting unit 250 transmits the multimedia data in different frequency bands to the respective access points through the base layers or the enhancement layers allocated to the access points. Herein, the above-described operation of the scheduler may be performed for all terminals communicable with the access points.

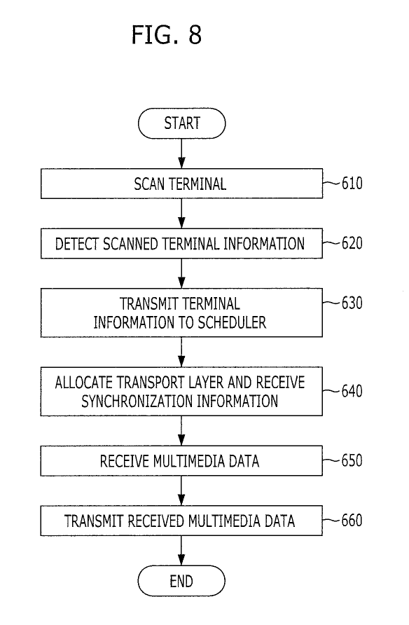

FIG. 8 is a flow chart illustrating an operation of the access point 310 illustrated in FIG. 4.

Referring to FIG. 8, the terminal scanning unit 311 scans a terminal at step 610.

At step 620, the terminal scanning unit 311 detects information of the scanned terminal. The terminal scanning unit 311 transmits the detected terminal information to the terminal information managing unit 312.

At step 630, the terminal information transmitting unit 313 transmits the terminal information, received from the terminal information managing unit 312, to the scheduler 200.

At step 640, the data receiving unit 314 is allocated multimedia data in a predetermined frequency band corresponding to an access point in different frequency bands, that is, transport layers in the predetermined frequency band corresponding to the multimedia data in the predetermined frequency band, and receives synchronization information.

At step 650, the data receiving unit 314 receives the multimedia data in the predetermined frequency band corresponding to the access point through the transport layers in the predetermined frequency band. The data receiving unit 314 outputs the multimedia data in the predetermined frequency band to the data transmitting unit 315.

At step 660, the data transmitting unit 315 transmits the multimedia data in the predetermined frequency band to the terminal through cooperation with other access points, as the multimedia data in the predetermined frequency band are synchronized with the access points according to synchronization information.

According to the present invention, the access points transmit the distance information about the terminal in a transmission region to the scheduler. On the basis of the distance information received from the access points, the scheduler allocates optimal multimedia data which are to be transmitted by each of the access points, i.e., multimedia data in a predetermined frequency band from the multimedia data in different frequency bands, and thus determines an optimal transport layer (e.g., a video (multimedia) layer). Thus, the same video frame is transmitted to the terminal through the multimedia data in different frequency bands, i.e., the video layers by cooperative communication. Accordingly, the gain of image quality can be improved as compared to the case of receiving vide data (e.g., multimedia data) through a single layer, even if the terminal is located outside the transmissible region. Also, the present invention is applicable to small-scale network environments or mobile IPTV environments.

As described above, the source terminal transmitting multimedia data schedules data by the scheduler and transmits the data through at least two access points, thereby making it possible to acquire cooperative diversity for multimedia data transmission. Also, a plurality of access points transmit the multimedia data in different frequency bands, thereby making it possible to prevent the waste of time slots for acquisition of cooperative diversity.

While the present invention has been described with respect to the specific embodiments, it will be apparent to those skilled in the art that various changes and modifications may be made without departing from the spirit and scope of the invention as defined in the following claims.

What is claimed is:

1. A multimedia data transmission apparatus in a multimedia service providing system, comprising:
a receiving unit configured to receive information of a terminal communicating with a plurality of access points from the access points;
an access point selecting unit configured to select two or more access points to communicate with the terminal which is to receive multimedia data in different frequency bands, based on the terminal information;
an allocating unit configured to allocate multimedia data in predetermine frequency bands to the two or more access points, respectively, from the multimedia data in different frequency bands such that the access points transmit the multimedia data in different frequency bands through cooperation therebetween; and
a data transmitting unit configured to transmit the multimedia data in different frequency bands to the respective access points through transport layers corresponding to the multimedia data in different frequency bands.

2. The multimedia data transmission apparatus of claim 1, wherein the terminal information comprises identifier information of the terminal and distance information between the terminal and the access points communicating with the terminal.

3. The multimedia data transmission apparatus of claim 2, wherein the allocating unit allocates multimedia data in a low frequency band among the multimedia data in different frequency bands to an access point positioned at a short distance from the terminal among the two or more access points, based on the distance information.

4. The multimedia data transmission apparatus of claim 3, wherein the data transmitting unit transmits the multimedia data in the low frequency band to the access point positioned at the short distance through transport layers in the low frequency band corresponding to the multimedia data in the low frequency band.

5. The multimedia data transmission apparatus of claim 2, wherein the allocating unit allocates multimedia data in a high frequency band among the multimedia data in different frequency bands to an access point positioned at a long distance from the terminal among the two or more access points, based on the distance information.

6. The multimedia data transmission apparatus of claim 5, wherein the data transmitting unit transmits the multimedia data in the high frequency band to the access point positioned at the long distance through transport layers in the high frequency band corresponding to the multimedia data in the high frequency band.

7. The multimedia data transmission apparatus of claim 1, further comprising a synchronization information generating unit configured to generate synchronization information to synchronize transmission time points of the multimedia data in different frequency bands, allocated to the two or more access points, respectively.

8. The multimedia data transmission apparatus of claim 7, wherein the data transmitting unit receives the synchronization information, synchronizes the multimedia data in different frequency bands through the synchronization information, and transmits the multimedia data to the two or more access points, respectively.

9. The multimedia data transmission apparatus of claim 1, wherein the allocating unit allocates transport layers in the predetermined frequency bands, corresponding to the multimedia data in the predetermined frequency bands, to the respective access points.

10. A multimedia data transmission method in a multimedia service providing system, comprising:
receiving information of a terminal communicating with a plurality of access points from the access points;
allocating multimedia data in predetermined frequency bands among multimedia data in different frequency bands to two or more access points communicating with the terminal, respectively, among the plurality of access points such that the two or more access points transmit the multimedia data in different frequency bands through cooperation therebetween; and
transmitting the multimedia data in different frequency bands to the respective access points through transport layers corresponding to the multimedia data in different frequency bands.

11. The multimedia data transmission method of claim 10, wherein the terminal information comprises identifier information of the terminal and distance information between the terminal and the access points communicating with the terminal.

12. The multimedia data transmission method of claim 11, wherein said allocating the multimedia data in predetermined frequency bands among the multimedia data in different frequency bands to the two or more access points communicating with the terminal, respectively, among the plurality of access points comprises allocating multimedia data in a low frequency band among the multimedia data in different frequency bands to an access point positioned at a short distance from the terminal among the two or more access points, based on the distance information.

13. The multimedia data transmission method of claim 12, wherein said transmitting the multimedia data in different frequency bands to the respective access points through the transport layers corresponding to the multimedia data in different frequency bands comprises transmitting the multimedia data in the low frequency band to the access point positioned at the short distance through transport layers in the low frequency band corresponding to the multimedia data in the low frequency band.

14. The multimedia data transmission method of claim 11, wherein said allocating the multimedia data in predetermined frequency bands among the multimedia data in different frequency bands to the two or more access points communicating with the terminal, respectively, among the plurality of access points comprises allocating multimedia data in a high frequency band among the multimedia data in different frequency bands to an access point positioned at a long distance from the terminal among the two or more access points, based on the distance information.

15. The multimedia data transmission method of claim 14, wherein said transmitting the multimedia data in different frequency bands to the respective access points through the transport layers corresponding to the multimedia data in different frequency bands comprises transmitting the multimedia data in the high frequency band to the access point positioned at the long distance through transport layers in the high frequency band corresponding to the multimedia data in the high frequency band.

16. The multimedia data transmission method of claim 10, wherein said allocating the multimedia data in predetermined frequency bands among the multimedia data in different frequency bands to the two or more access points communicating with the terminal, respectively, among the plurality of access points comprises allocating transport layers in the predetermined frequency bands, corresponding to the multimedia data in the predetermined frequency bands, to the respective access points.

17. The multimedia data transmission method of claim 10, further comprising generating and transmitting synchronization information to synchronize transmission time points of the multimedia data in different frequency bands, allocated to the two or more access points, respectively.
